(19) United States
(12) Patent Application Publication
(10) Pub. No.: US 2010/0315659 A1
(43) Pub. Date: Dec. 16, 2010

(54) ALLOCATION PROGRAM, ALLOCATION DEVICE AND ALLOCATION METHOD

(75) Inventor: Koji Tatsuno, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/796,577

(22) Filed: Jun. 8, 2010

(30) Foreign Application Priority Data
Jun. 10, 2009 (JP) 2009-138909

(51) Int. Cl. G06K 15/10

(52) U.S. Cl. 358/1.5

(57) ABSTRACT

An allocation device includes: an allocation candidate information acquisition unit that acquires a plurality of allocation candidate positions and the number of the allocation candidate positions in the case where print target images are allocated on a printing medium; a printing number acquisition unit that acquires the number of the print target images to be printed, the number being smaller than the number of the allocation candidate positions; and an allocation unit that allocates the print target images to the plurality of allocation candidate positions so that a highest cutting efficiency is obtained in the case where the printing medium, on which the print target images to be printed have been allocated and printed to the plurality of allocation candidate positions, is cut into segments for the individual print target images.

### BACKGROUND

1. Technical Field

The present invention relates to an allocation program, an allocation device and an allocation method.

2. Related Art

In the related art, a technique in which a plurality of print target images of the same size are allocated to be printed on one printing medium is widely known. For example, JP-A-2008-142969 discloses a technique in which a plurality of rectangular print target images of the same size are allocated on a rectangular printing medium. In the related art, the print target images are allocated on the printing medium in which printed target images are arranged vertically and horizontally in a mixed manner so that as many print target images as possible are allocated on the printing medium to perform printing.

In the related art, in the case where a printing medium is cut into individual print target image segments, the cutting efficiency of the printing medium is not high.

Namely, in the related art, because as many print target images as possible are arranged on a printing medium, a case in which the number of print target images to be printed is smaller than the number of the allocation candidate positions on the printing medium is not considered. In the case where the number of the print target images to be printed is smaller than the number of the allocation candidate positions on the recording medium, the images are allocated on arbitrary positions, so that a plurality of allocation results may be assumed. When the plurality of allocation results are compared with each other, although the cutting efficiency is found to be different in each result, allocation cannot be performed so as to improve the cutting efficiency in the related art.

### SUMMARY

An advantage of some aspects of the invention is to provide a technique for improving cutting efficiency in the case where a printing medium is cut into individual print target image segments.

According to an aspect of the invention, print target images are allocated on a recording medium so that a highest cutting efficiency is obtained in the case where the print target images, the number of which is smaller than the number of allocation candidate positions, are allocated and printed to the recording medium, and the printing medium is cut into segments for each of the print target images comes to be the highest. Accordingly, the printing medium on which printing has been performed in accordance with the allocation can be efficiently cut into the segments for individual print target images.

In this case, the plurality of the allocation candidate positions may be positions to which the print target images can be allocated on the printing medium. For example, such configuration may be adopted in which information that indicates allocation candidate positions may be defined by information that indicates segments into which a printing medium is divided in a size of each print target image. The number of the allocation candidate positions is the number of the positions in which the print target images can be allocated on a printing medium, and the number may be determined in accordance with a predetermined rule to specify the allocation candidate positions. Accordingly, such number may be equal to the maximum number of the print target images allocated on a printing medium, or may be smaller than the maximum number. For example, in the case where rectangular print target images are allowed to be rotated and allocated close to each other on a rectangular printing medium, the number of the allocation candidate positions is equal to the maximum number of the print target images arranged on the printing medium. On the other hand, in the case where the rectangular print target images are not allowed to be rotated and allocated close to each other on a rectangular printing medium, the number of the allocation candidate is smaller than the maximum number of the print target images arranged on the printing medium.

The number of print target images may be smaller than the number of allocation candidate positions. Namely, print target images are allocated in the number smaller than the number of allocation candidate positions to which the print target images can be allocated, so that combinations of positions to which the images are allocated may be optionally selected in the allocation candidate positions. A status in which the number of print target images is smaller than the number of allocation candidate positions corresponds to a status in which printing is performed without allocating the maximum number of target images to a plurality of the allocation candidate positions on a printing medium. Such status is considered in the case where unnecessary printing of print target images is precluded to suppress an amount of colorant and print time.

In an allocation function, allocation may be performed so that a highest cutting efficiency is obtained. Namely, the number of print target images is smaller than the number of allocation candidate positions, so that combinations of positions to which images are allocated may be optionally selected in the allocation candidate positions. Consequently, a combination in which the cutting efficiency comes to be the highest may be specified from among the combinations. Several techniques may be employed for allocation such that the cutting efficiency comes to be the highest. For example, a configuration may be employed in which indexes indicating the cutting efficiency of each of the combinations may be specified to be compared with each other so as to select a combination of allocation candidate positions having the highest cutting efficiency, for printing in the number corresponding to the printing number from among all of the allocation candidate positions. A combination in which the cutting efficiency does not apparently come to be high may be excluded, and then indexes for indicating the cutting efficiency may be specified in the other combinations.

The cutting efficiency may represent efficiency in the case where a printing medium on which print target images are printed is cut into segments for each of the print target images. For example, such configuration may be adopted in which operating efficiency or the like in the cutting may conceive the cutting efficiency. This advantage enables work load to be suppressed during printing medium cutting.

The cutting efficiency can be defined in view of several indexes. For example, a larger non-printed portion which can be cut from a printing medium by a set of cutting operations makes the cutting operations be more efficiently performed. Accordingly, such configuration may be adopted in which print target images may be allocated to allocation candidate positions so that one continuous cutoff line is cut to the extent that a non-printed portion can be separated from a printing medium and comes to be the largest. According to this configuration, the set of the cutting operations makes a large non-printed portion be separated from a printing medium, as compared with other combinations for the allocations. Consequently, operation for separating an unnecessary non-printed portion can be efficiently performed in a printing medium after printing is finished.

Although the cutting operation is performed in an arbitrary sequence, the cutting efficiency in each combination of the allocations may be compared with each other on the basis of the assumption that the set of the cutting operation is performed in a specific sequence. For example, the set of the cutting operation may be assumed to separate as large a non-printed portion as possible from a printing medium, or a portion selected in accordance with a predetermined basis (for example, a polygonal portion circumscribing print target images) may be assumed to be separated from the printing medium. More specifically, combinations for selecting allocation positions in the number corresponding to a printing number from allocation candidate positions may be specified, and then an area of a non-printed portion separable by a set of cutting operations may be specified in each of the combinations, and then allocation may be performed in accordance with a combination having the largest area separable.

Furthermore, cutting in smaller numbers may be considered to have higher cutting efficiency. For example, print target images may be allocated to allocation candidate positions such that the number of line segments, which are the cutoff lines used in the case where a printing medium on which the images have been allocated to the allocation candidate positions is cut into segments for individual print target images, comes to be the least. Namely, in the case where the printing medium is linearly cut along the line segments as the cutoff lines repeatedly to cut off the print target images, the print target images can be linearly cut off. In this case, the operation in which cutting is performed along the line segments can be performed continuously, and the operation in which cutting is performed along the line segments may be assumed to be one cutting operation. Accordingly, the print target images are allocated to the allocation candidate positions such that the number of the line segments as the cutoff lines comes to be the least, then the print target images can be cut with the least cutting operations.

The line segments as the cutoff lines used in the case where a recording medium is cut into segments for each of print target images are line segments with which each of the adjacent print target images is separated from each other and with which the print target images are separated from a non-printed portion. Furthermore, in this case, because the number of the line segments may be specified as an index indicating the cutting efficiency in the case where a printing medium is cut into segments for individual print target images, lines necessarily cut off in the cutting operation (for example, a polygonal portion circumscribing the print target image) may be excluded from the line segments used for considering the cutting efficiency.

Furthermore, cutting in a shorter length may be considered to have higher cutting efficiency. For example, a configuration may be adopted in which print target images are allocated to allocation candidate positions such that the sum of the lengths of cutoff lines comes to be the least, when the printing medium on which the images have been allocated to the allocation candidate positions is cut into segments for the individual print target images. Namely, in the case where the printing medium is cut to separate the print target images, the smaller sum total of lengths to be cut leads to less operating procedures for the print target images to be cut off. Accordingly, print target images are allocated to allocation candidate positions such that the sum of the lengths of cutoff lines comes to be the least, so that the print target images can be cut off with less operating procedures.

The cutoff line used in the case where a printing medium is cut into segments for individual print target images are line segments with which each of the adjacent print target images is separated from each other and with which the print target images are separated from a non-printed portion. Furthermore, lines necessarily cut off in the cutting operation (for example, a polygonal portion circumscribing the print target image) may be excluded from the line segments used for considering the cutting efficiency.

Moreover, a technique according to an aspect of the invention in which print target images are allocated to allocation candidate positions so as to achieve high cutting efficiency can be applied to a program, a device, and a method. Such a program, a device, and a method may be implemented in a single printing apparatus or may be implemented in combination with a plurality of devices. The invention may include various embodiments. For example, a computer, in conjunction with a printing apparatus, can provide a program, a device, and a method according to an aspect of the invention. The invention can be arbitrarily modified so as to be partially configured with software and hardware. Furthermore, the invention may be applicable even if the invention is applied to a recording medium which records a program that controls a printing apparatus. Obviously, such a recording medium may be a magnetic recording medium or a magneto-optical recording medium, or any recording mediums which will be developed and similarly used as a recording medium in the future.

### BRIEF DESCRIPTION OF THE DRAWINGS

The invention will be described with reference to the accompanying drawings, wherein like numbers reference like elements.

FIG. 1 is a block diagram illustrating a configuration of an allocation device.

FIG. 2 is a flowchart illustrating a print process.

FIG. 3 is a flowchart illustrating an allocation process.

FIG. 4A illustrates an example of a printing medium, FIG. 4B illustrates an example of a print target image, FIG. 4C illustrates an example of allocation candidate positions, FIG. 4D illustrates an example of allocation, and FIG. 4E illustrates another example of allocation.

FIG. 5 is a flowchart illustrating an allocation process.

FIG. 6A illustrates line segments as cutoff lines, FIG. 6B illustrates an example of allocation, FIG. 6C illustrates another example of allocation, FIG. 6D illustrates an example of a rectangle circumscribing print targets, and FIG. 6E illustrates another example of a rectangle circumscribing print targets.

FIG. 7 is a flowchart illustrating an allocation process.

FIG. 8 is another flowchart illustrating an allocation process.

FIG. 9A illustrates lengths of cutoff lines, and FIG. 9B illustrates other lengths of cutoff lines.

### DESCRIPTION OF EXEMPLARY EMBODIMENTS

Embodiments of the invention will be described hereinafter in the following sequence: firstly, a configuration of an allocation device; secondary, an allocation process; and thirdly, other embodiments.

### Configuration of Allocation Device

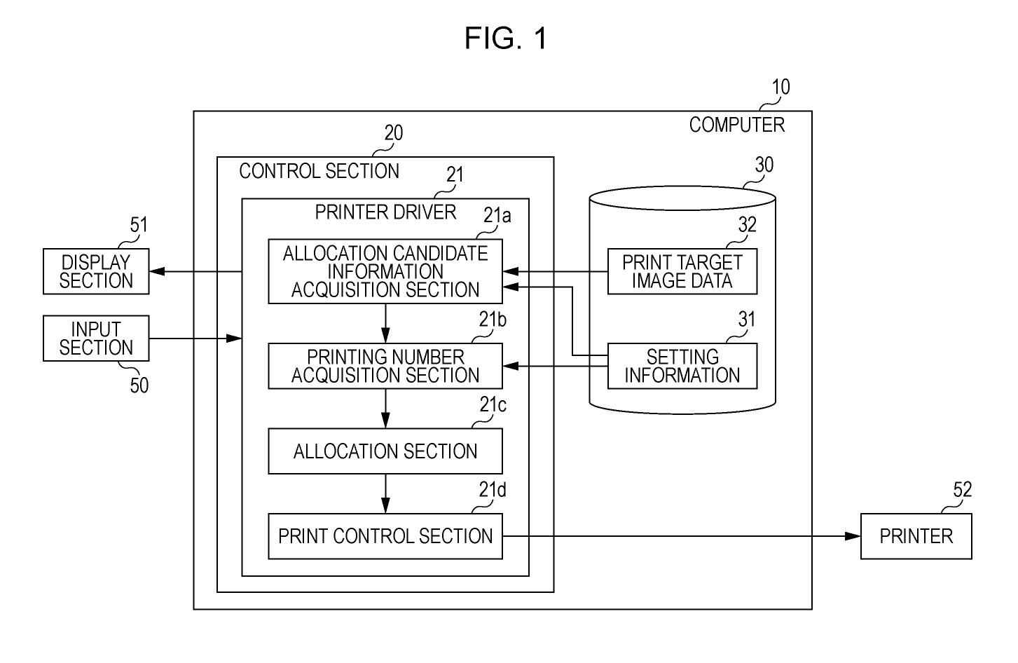

FIG. 1 is a block diagram illustrating the configuration of a computer 10 according to an embodiment of the invention. The computer 10 has a control section 20 including a random access memory (RAM), a read-only memory (ROM), and a central processing unit (CPU) (all are not shown) and has a recording medium 30. The control section 20 can execute a program stored in the ROM and the recording medium 30. In the embodiment, a printer driver 21, an application program and the like can be executed as such a program.

The computer 10 includes an interface (not shown). The computer 10 is connected to an input section 50, a display section 51, and a printer 52 through the interface. The input section 50 is a device such as a mouse or a keyboard that outputs a signal corresponding to a content input by a user. The control section 20 specifies the content input by the user on the basis of the signal. The display section 51 is a device such as a display device that displays an arbitrary image in accordance with a signal output from the control section 20. In the embodiment, the display section 51 displays a user interface for utilizing functions of the printer driver 21 and the application program. The printer 52 is a printing apparatus that prints an image, which is indicated by print data output from the control section 20, on the basis of the print data.

The recording medium 30 records setting information 31 indicating print settings applied to a print target and records print target image data 32. The setting information 31 is information indicating print settings to be applied in the case where the printer driver 21 operates to print a print target image. The setting information 31 is also information in which individual contents of the settings are made to correspond to a plurality of items of the print settings. The setting information 31 may be preliminarily determined or may be determined by a user. In the embodiment, the setting information 31 includes information for specifying allocation candidate positions of print target images and the number of the allocation candidate positions. For example, the setting information 31 includes information indicating a size of a print target image to be printed on a printing medium, a printing number, and a size of the printing medium. The print target image data 32 is data indicating a print target image to be printed on a recording medium. Accordingly, the print target image data 32 may be data used for writing the print target image on the printing medium, and it may be raster data, vector data, or data including characters or the like.

The printer driver 21 is a module which applies printing settings indicated by the setting information 31 to a print target to perform printing. When an application program or the like directs to print a print target image, the printer driver 21 is launched to perform a print process. In the embodiment, the printer driver 21 includes an allocation program. In the case where the control section 20 controls the printer driver 21 to run, the control section 20 performs allocation in accordance with the setting information 31 to perform printing. In other words, the control section 20 performs a process arising from the printer drive 21, so that the computer 10 functions as an allocation device.

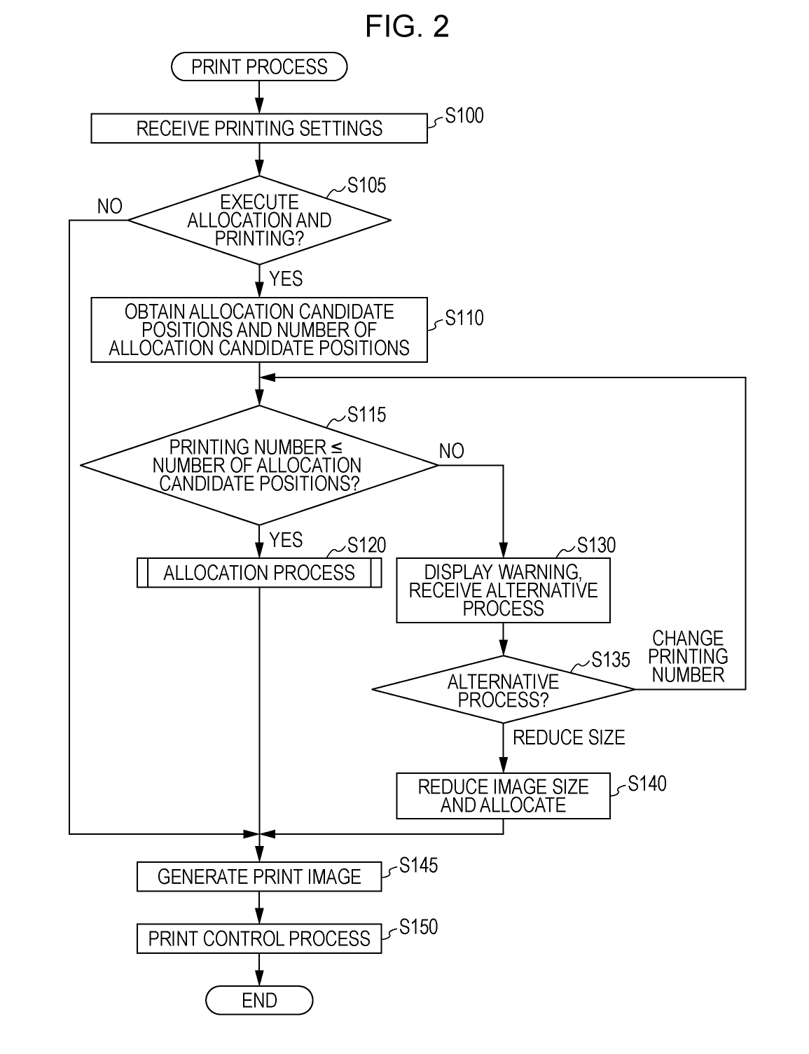

The printer driver 21 includes an allocation candidate information acquisition section 21a, a printing number acquisition section 21b, and an allocation section 21c in order to perform allocation process in the course of a print process. FIG. 2 is a flowchart illustrating a print process by the printer driver 21. In the case where an application program or the like directs to start printing a print target, the control section 20 runs the printer driver 21 to start the print process illustrated in FIG. 2.

Once the print process has started, the control section 20 receives printing settings owing to a process performed by the printer driver 21 (step S100 (hereinafter called as Sn, n=1, 2, 3 and so on)). Namely, the control section 20 outputs a control signal to the display section 51 to display the user interface for determining the printing settings on the display section 51. The control section 20 accepts input operation by a user on the basis of information output from the input section 50, and then the control section 20 produces the setting information 31 in accordance with contents of the accepted input to store the information in the recording medium 30. Namely, information indicating a size of an image to be printed on the printing medium, a printing number, and a size of a printing medium is written in the setting information 31.

Subsequently, the control section 20 determines on the basis of the setting information 31 whether allocation printing is directed to be performed or not (S105). In S105, in the case where the control section 20 determines that the allocation printing is not directed to be performed, S110 to S140 are skipped. In S105, in the case where the control section 20 determines that the allocation printing is directed to be performed, the control section 20 performs a process for performing allocation in accordance with the setting information 31 after S110.

For such a process for the allocation, the control section 20 obtains allocation candidate positions and the number of the allocation candidate positions by a process performed by the allocation candidate information acquisition section 21a (S110). In the embodiment, a layout in which the print target images in the maximum number are allocated on a printing medium is specified, and positions to which the print target images can be allocated within the layout are determined as the allocation candidate positions. Namely, on the basis of the setting information 31 owing to a process performed by the allocation candidate information acquisition section 21a, the control section 20 specifies a size of a printing medium and a size of a print target image specified in the setting information 31. Then, positions in which the print target images having the specified size are allocated as many as possible on the printing medium having the specified size while permitting the rotation of the print target images, are specified as the allocation candidate positions. In addition, not only the allocation candidate positions, but the number of the allocation candidate positions is also specified.

Various techniques can be employed as a technique for specifying the allocation candidate positions. For example, rectangular print target images are assumed to be arranged as many as possible such that short sides of the rectangular print target images are in parallel with short sides of a rectangular printing medium. In the case where a white space exists, the print target images are rotated such that long sides thereof are in parallel with short sides of the printing medium. Then, in the case where the rotated print target images can be arranged on the white space, the rotated print target images are arranged on the white space, and then the sum total of the arranged images is counted. Furthermore, rectangular print target images are assumed to be arranged as many as possible such that long sides of the rectangular print target images are in parallel with short sides of a rectangular printing medium. In the case where a white space exists, the print target images are rotated such that short sides thereof are in parallel with short sides of the printing medium. Then, in the case where the rotated print target images can be arranged on the white space, the rotated print target images are arranged on the white space, and then the sum total of the arranged images is counted. A configuration may be adopted in which the arrangement having the sum total of a larger number is regarded as having allocation candidate positions in which the print target images are maximally arranged on the printing medium.

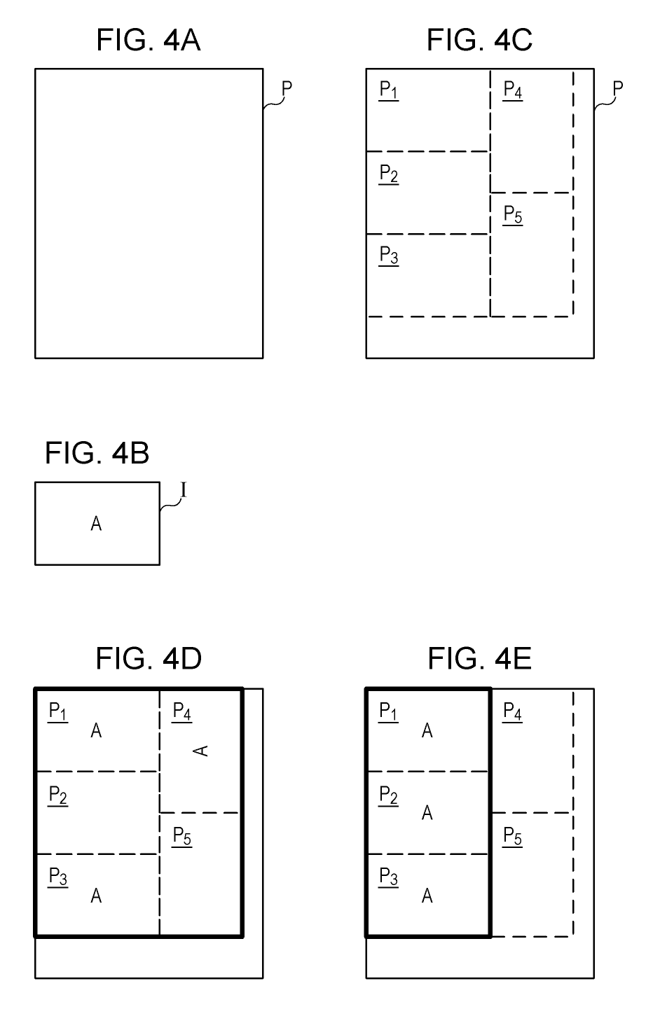

FIG. 4A illustrates an example of a rectangular printing medium P. FIG. 4B illustrates an example of a rectangular print target image I. In the examples, the printing medium P has a width of 5.5 inches and a height of 7 inches, and the print target image I has a width of 3 inches and a height of 2 inches. The print target image I is illustrated with a character “A” thereon in order to indicate left, right, upper, and lower directions of the image. FIG. 4C illustrates allocation candidate positions P₁ to P₅ in which the print target images I are maximally allocated on the printing medium P illustrated in FIG. 4A and FIG. 4B. Namely, in the example, long sides of the print target images I are in parallel with short sides of the printing medium P, and three print target images I are arranged close to each other from the upper left of the printing medium P. Furthermore, two print target images I can be arranged on the right side of the three images I while the short sides of the two print target images I are in parallel with the short sides of the printing medium P. In FIG. 4C, the peripheries of the allocation candidate positions are indicated by dashed lines.

After the control section 20 obtains the allocation candidate positions and the number of the allocation candidate positions in S110, on the basis of the setting information 31, the control section 20 obtains a printing number by the process performed by the printing number acquisition section 21b, and then determines whether or not the printing number is smaller than the number of the allocation candidate positions (S115). In S115, in the case where the control section 20 dos not determine that the printing number is smaller than the number of the allocation candidate positions, the control section 20 displays a warning on the display section 51 and then receives alternative process (S130). Namely, the control section 20 outputs a control signal to the display section 51 to display the warning on the display section 51 that the print target images cannot be printed on a single printing medium in the specified printing number without changing the specified size of the print target images. Furthermore, the control section 20 displays a selection screen on the display section 51 asking which one of changing the printing number and reducing the size is to be selected as the alternative process. The control section 20 receives the input from the input section 50 and determines whether the alternative process is the change of the printing number or the reducing of the size of printing images. (S135).

In the case where the control section 20 determines that the user selects changing the printing number in S135, the control section 20 repeats the process from S115. In the case where the control section 20 determines that the user selects reducing the size in S135, each size of the print target images is reduced to allocate the images (S140). Namely, the control section 20 reduces each size of the print target images until the print target images in the printing number can be arranged on the printing medium and specifies allocation in which the size-reduced print target images are arranged.

### Allocation Process

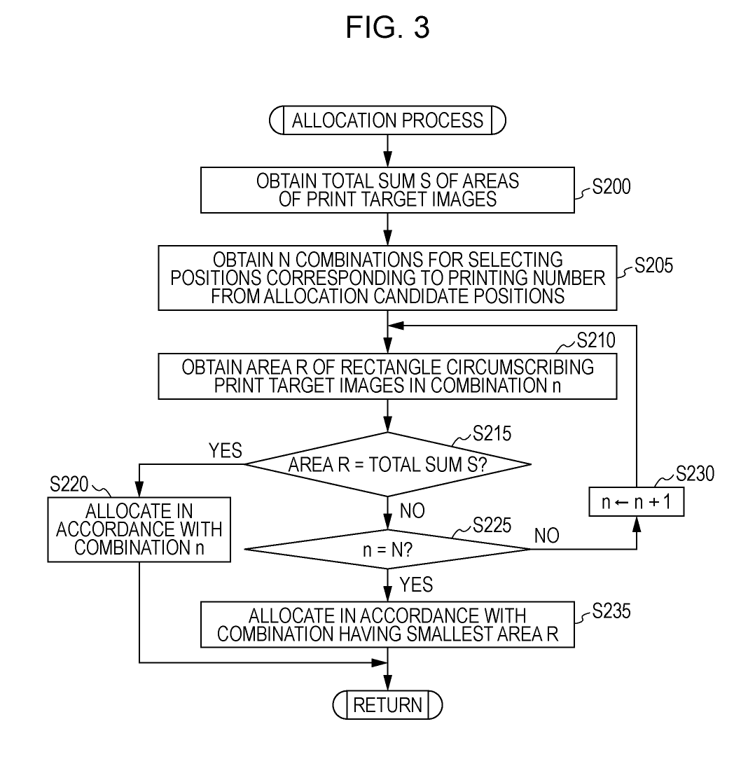

On the other hand, in the case where the control section 20 determines that the printing number is smaller than the number of the allocation candidate positions in S115, the control section 20 performs an allocation process by the allocation section 21c (S120). FIG. 3 is a flowchart illustrating the allocation process in S120. In the allocation process, the control section 20 first obtains the sum total S of areas of the individual print target images (S200). The sum total S is a product of an area of a print target image and a printing number.

Subsequently, the control section 20 obtains N combinations for selecting positions corresponding to the printing number from the allocation candidate positions (S205). Namely, prospective combinations of positions, which may be adopted in the case where the print target images in the printing number are arranged in the allocation candidate positions, are specified. When the number of the allocation candidate positions and the printing number are respectively denoted by “i” and “j”, N is represented as “N=ᵢCⱼ”, which is a combination for selecting j from i. For example, in the example illustrated in FIG. 4C, because the number of the allocation candidate positions is five, N=₅C₃=10 is represented in the case where the printing number is three. In this case, the number from one to N is given to each of the specified combinations.

In the embodiment, the print target images are allocated to the allocation candidate positions such that a non-printed portion comes to be the largest, the non-printed portion being separable from the printing medium by cutting one continuous cutoff line. In the embodiment, linear cutting is assumed to be repeated, and cutting efficiency is considered to come to be the highest in the case where a non-printed portion, which can be separated by linearly cutting the printing medium first, comes to be the largest. FIGS. 4D and 4E illustrate examples in which two combinations are extracted from the combinations which are obtained by allocating three print target images to the allocation candidate positions illustrated in FIG. 4C. In the examples, each of the allocation candidate positions is provided with a character “A” to represent that the print target images are arranged in the allocation candidate positions. Namely, each of the print target images is arranged in each allocation candidate position of P₁, P₃, and P₄ in the example illustrated in FIG. 4D, and each of the print target images is arranged in each allocation candidate position of P₁, P₂, and P₃ in the example illustrated in FIG. 4E.

In the case where a printing medium is assumed to be linearly cut in each of such combinations of allocation, in many cases, the printing medium is cut along the sides of a rectangle circumscribing the print target images by a set of operations in the first cutting to remove a non-printed portion. For example, in the examples illustrated in FIGS. 4D and 4E, each of the rectangles circumscribing the print target images is indicated by bold lines. In order to perform cutting by a set of operations, in many cases, linear cutting is performed along line segments which are inside a periphery of the printing medium P and which correspond to the sides of the rectangle. In FIG. 4D, in the case where the printing medium is cut along a line including a lower short side of the rectangle indicated by the bold line, a larger non-printed portion is able to be linearly cut to be separated from the printing medium. In FIG. 4E, in the case where the printing medium is cut along a line including a long side, or a right side of the rectangle indicated by the bold line, so that a larger non-printed portion is able to be linearly cut to be separated from the printing medium. In this way, the larger non-printed portion which can be separated from the printing medium by a set of operations in the first cutting leads to reducing the number of processes in the cutting operations for separating the printing medium into segments for the individual print target images. Consequently, a linear cutoff line is assumed to be one continuous cutoff line, and the cutting efficiency can be considered to be the highest in the allocation in which the non-printed portion separated from the printing medium comes to be the largest, by cutting the non-printed portion along such a cutoff line.

Accordingly, in the embodiment, in the case where linear cutting is repeated, in order to specify the allocation in which the non-printed portion being able to be separated from the printing medium in the first cutting comes to be the largest, the control section 20 obtains an area R of the rectangle circumscribing the print target images in a combination n (n is an integer of one to N) (S210). When S210 is first performed, the n is set to be one. For example, in the example illustrated in FIG. 4D, the area R of the rectangle circumscribing the print target images is a product of the sum of a length of a long side of the print target image I and a length of a short side of the image I and the sum of lengths of short sides of three images I, and in the example illustrated in FIG. 4E, the area R of the rectangle circumscribing print target images is a product of a length of the long side of the image I and the sum of lengths of short sides of three images I.

Subsequently, in the combination n, the control section 20 determines whether the area R of the rectangle circumscribing the print target images is equal to the sum total S of the areas of the print target images or not (S215). In S215, in the case where the control section 20 determines that the area R is equal to the sum total S, the print target images are arranged in accordance with the combination n with the result that a non-printed portion is not included in a rectangle circumscribing the arranged print target images. Accordingly, the arrangement according to the combination n enables the allocation to be performed such that the non-printed portion being able to be separated from the printing medium in the first cutting comes to be the largest. Consequently, the control section 20 performs the allocation in accordance with the combination n (S220) and then returns to the process illustrated in FIG. 2.

On the other hand, in the case where the control section 20 does not determine that the area R is equal to the sum total S in S215, the control section 20 determines whether n is equal to N or not (S225). Namely, the control section 20 determines whether the area R has been compared with the sum total S in all of the combinations or not. In the case where the control section 20 does not determine that n is equal to N in S225, the control section 20 increments n (S230) to repeat the steps from S210. Meanwhile, in the case where the control section 20 determines that n is equal to N in S225, the control section 20 specifies a combination in which the area R comes to be the smallest among N combinations, so that the allocation is performed in accordance with the specified combination (S235). Then, the control section 20 returns to the process illustrated in FIG. 2.

After returning to the process illustrated in FIG. 2, the control section 20 generates a print image by a print control section 21d (S145) to perform a print control process for printing the print image (S150). Namely, the control section 20 performs a writing process in a printable region used for performing printing on the printing medium, such that the print target images are arranged in each candidate position to which each of the print target images is allocated while rotating the print target images if needed. The control section 20 performs a color conversion process and a halftone process on the basis of the print image generated by the writing process to generate the print data, and then the print data is output to the printer 52. Consequently, printing can be performed on the printing medium in which the allocation has been performed through the allocation process illustrated in FIG. 3.

According to the above mentioned processes, by S220 or S235 in FIG. 3, the allocation can be performed such that an area R of a rectangle circumscribing print target images is equal to the sum total S or such that the area R is larger than the sum total S but the smallest among the possible combinations. Accordingly, a combination of arrangement can be employed from among the possible combinations when print target images are printed in the specified printing number, so that printing can be performed in which the largest non-printed portion relative to the other combinations can be separated in the first cutting. Consequently, the cutting operation can be performed with high efficiency to separate the printing medium into segments for the individual print target images. In the case where the control section 20 does not determine that the allocation printing is directed to be performed in S105 and in the case where S140 has been performed, the printing steps of S145 and S150 are performed. Namely, in the case where the control section 20 does not determine that the allocation printing is directed to be performed in S105, each of the print target images is printed on the printing medium without performing the allocation. Furthermore, in the case where the allocation has been performed by reducing the size of each image in S140, a print image for performing printing in accordance with the allocation of the size-reduced images is generated to perform the printing process.

### OTHER EMBODIMENTS

The above embodiment is an example for practicing the invention, and the invention may employ various embodiments in so far as print target images are allocated to allocation candidate positions so as to achieve high cutting efficiency. For example, the allocation candidate positions are not limited to such allocation candidate positions in which print target images in the maximum number are arranged on a printing medium. Allocation candidate positions to which the print target images are arranged on the printing medium without rotating the print target images may be employed.

In the above embodiment, although a size of each of print target images is uniform, the invention may be applied to arranging print target images of different sizes on a printing medium. Furthermore, in the above embodiment, although printing is performed without forming a frame on the periphery of print target images, the frame may be formed. In this case, allocation candidate positions on a printing medium are considered on the basis of a size along a periphery of the frames of the print target images. Furthermore, in the embodiment, although the cutting operation in which the linear cutting is repeated has been assumed, another type of cutting operation in which both the linear cutting performed on a printing medium and the cutting in a direction different by 90 degrees during the linear cutting are repeated, may be assumed. In this case, it is assumed that the printing medium is cut from one side to another side along one continuous cutoff line which allows the cutting to turn by 90 degrees during the linear cutting, and allocation may be performed such that a non-printed portion to be separated from the printing medium by the cutting comes to be the largest.

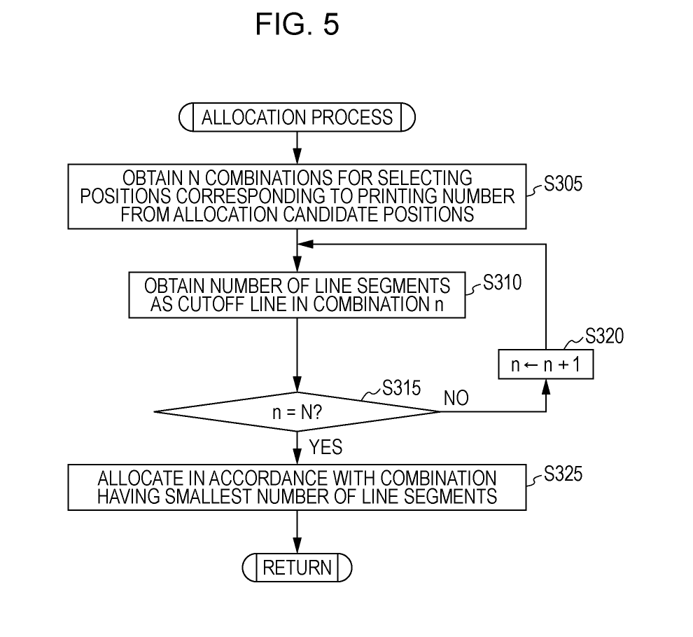

Furthermore, the allocation which causes the cutting operation to be carried out in the smallest number may be considered to have the highest cutting efficiency. This configuration can be achieved by the control section 20 performing an allocation process illustrated in FIG. 5 at S120 in FIG. 2 in the same configuration as in FIGS. 1 and 2. Note that S305 in the allocation process illustrated in FIG. 5 is the same step as S205 described above.

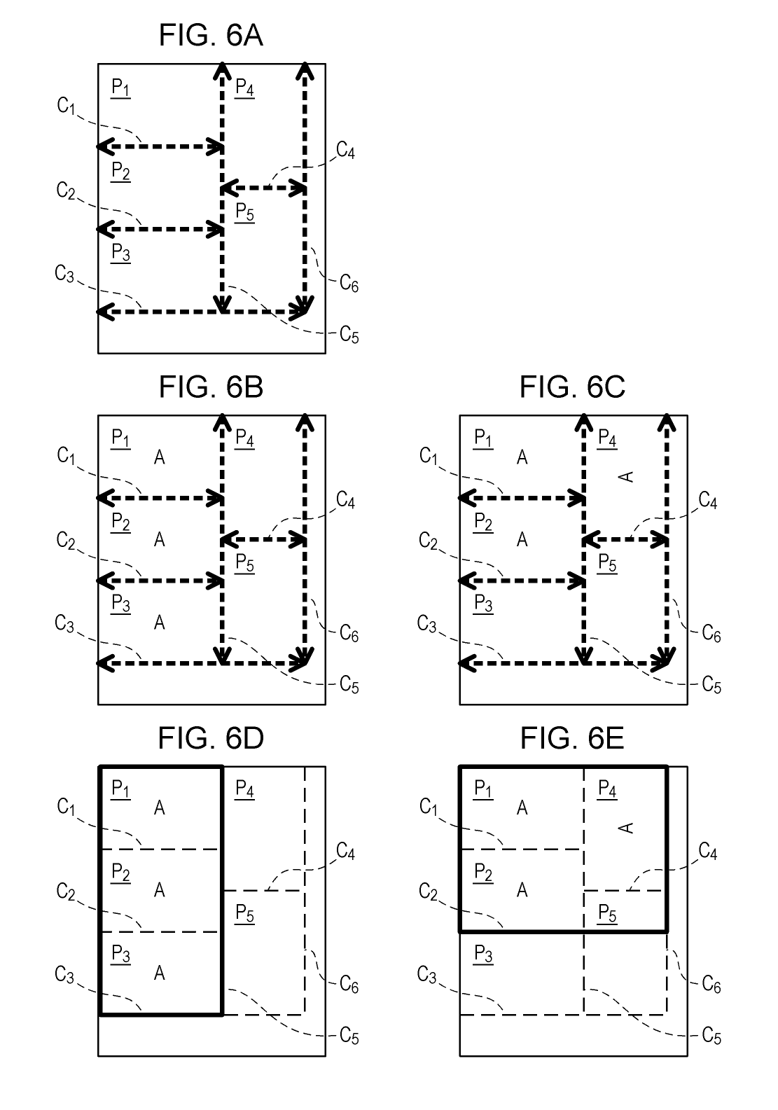

After N combinations have been obtained, the control section 20 obtains the number of line segments as cutoff lines in a combination n while regarding the initial value of n as one (S310). In the embodiment, among defining lines that define each of allocation candidate positions, a defining line corresponding with a side of each print target image arranged in an allocation candidate position is counted as a line segment as a cutoff line in a combination n. FIG. 6A illustrates defining lines C₁ to C₆ with respect to the examples same as those illustrated in FIGS. 4A to 4C, each of the defining lines being represented by a dashed arrow indicating two ends of each defining line. Note that in the case where one defining line is an extension of another defining line, such two defining lines are regarded as one defining line.

FIGS. 6B and 6C illustrate examples of two combinations each extracted from the combinations in which three print target images are allocated to the allocation candidate positions illustrated in FIG. 6A. In FIG. 6B, the print target images are allocated to the allocation candidate positions P₁, P₂, and P₃. In FIG. 6C, the print target images are allocated to the allocation candidate positions P₁, P₂, and P₄. With respect to FIG. 6B, because defining lines corresponding with sides of the print target images allocated to the allocation candidate positions P₁, P₂, and P₃ are C₁, C₂, C₃, and C₅, these defining lines are regarded as cutoff lines which will be actually cut, so that the number thereof is counted. In the example illustrated in FIG. 6C, because defining lines corresponding with sides of the print target images allocated to the allocation candidate positions P₁, P₂, and P₄ are C₁, C₂, C₄, C₅, and C₆, these defining lines are regarded as the cutoff lines which will be actually cut, so that the number thereof is counted. Accordingly, in FIGS. 6B and 6C, each of the numbers of the line segments as the cutoff lines is counted as 4 and 5.

Subsequently, the control section 20 determines whether a variable n indicating a combination is equal to N indicating the total number of the combinations or not (S315). In the case where the control section 20 does not determine that n is equal to N in S315, n is incremented (S320) to repeat the steps from the S310. On the other hand, in the case where the control section 20 determines that n is equal to N in S315, the control section 20 specifies a combination in which the number of the line segments which has been counted in S310 comes to be the smallest, and then allocation is performed in accordance with the specified combination (S325). After these steps have finished, the control section 20 returns to the process illustrated in FIG. 2 to perform the print control process. Consequently, among the combinations of arrangement which can be employed in printing the print target images in the specified printing number, printing can be performed in a combination of arrangement in which the print target images can be separated by the cutting operation in the smallest number relative to other combinations. As a result, the cutting operation can be performed with high efficiency to separate the printing medium into segments for the individual print target images.

In each of the embodiments, although print target images are arranged close to each other without providing a printing medium with a frame or a white space, the white space which is to be separated by cutting operation may be provided on the printing medium. In this case, in the example illustrated in FIG. 6A, for example, a cutoff line is prepared in the vicinity of a frame on an upper side of the printing medium in parallel with the frame, and another cutoff line is formed in the vicinity of a frame on a left side of the printing medium in parallel with the frame.

Furthermore, in the case where a cutoff line which is necessarily cut in any combination exists when a certain cutting method is assumed, the number of cutoff lines may be counted while excluding such a cutoff line to be necessarily cut. For example, in the example illustrated in FIG. 6A, when a cutting method in which outermost defining lines are firstly cut to separate print target images in any combination is assumed, the defining lines C₃ and C₆ are necessarily cut in any combination. Accordingly, the outermost defining lines are excluded from a count of line segment as the cutoff line. Consequently, candidates for counting are the defining lines C₁, C₂, C₄, and C₅. Then, in an arbitrary combination, line segments corresponding with sides of print target images may be counted; the line segments to be counted are selected from among the defining lines C₁, C₂, C₄, and C₅. For example, in the example illustrated in FIG. 6B, such line segments are three defining lines C₁, C₂, and C₅. In the example illustrated in FIG. 6C, such line segments are four defining lines C₁, C₂, C₄, and C₅.

The line segments to be excluded are not limited to the outermost cutoff line candidates, and cutoff line candidates overlapping the periphery of a rectangle circumscribing print target images may be excluded. For example, with respect to the print target images arranged in the manner illustrated in FIGS. 6B and 6C, rectangles circumscribing the print target images are the rectangles indicated by bold lines in FIGS. 6D and 6E. On the assumption that most operators star the cutting operation from cutting the largest rectangle, defining lines corresponding with sides of the rectangle circumscribing the print target images are necessarily cut. Accordingly, the defining lines corresponding with the sides of the rectangle may be excluded. In this case, in the example illustrated in FIG. 6D, the defining lines C₃ and C₅ are excluded, and the defining lines C₁ and C₂ are counted. On the other hand, in the example illustrated in FIG. 6E, the defining lines C₂ and C₆ are excluded, and the defining lines C₁, C₄, and C₅ are counted.

Furthermore, before the number of the line segments as the cutoff lines is counted, a combination of allocation in which the number of the line segments as the cutoff lines is obviously larger than other combinations may be excluded. For example, in the case where three print target images are arranged in the allocation candidate positions illustrated in FIG. 6A, the number of cutting does not come to be the least in an arrangement including a print target image having a side not overlapping the sides of other print target images (for example, the arrangement in the allocation candidate positions P₁, P₃, and P₄).

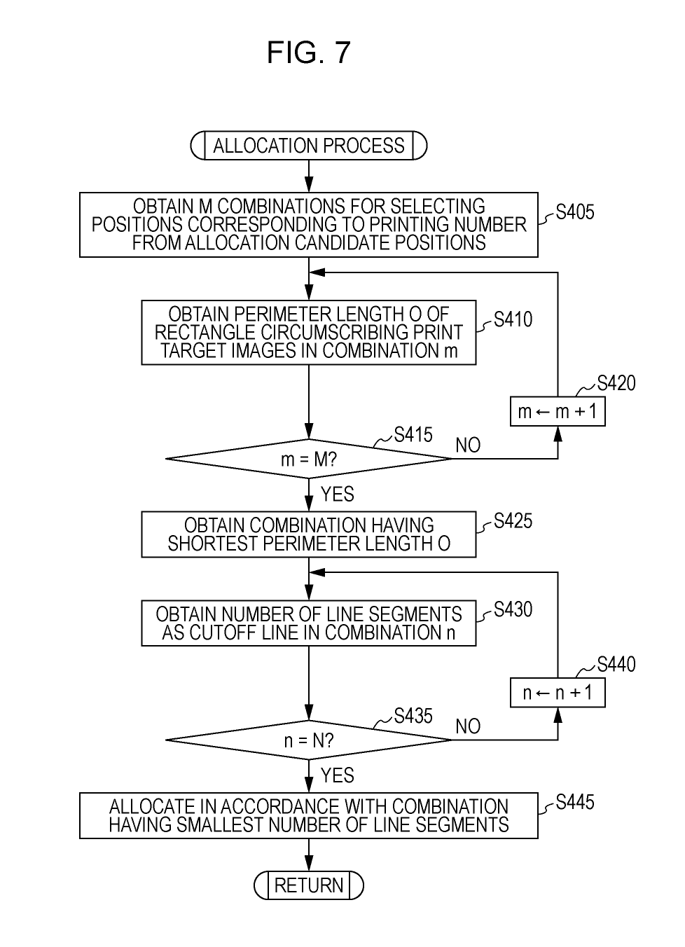

FIG. 7 illustrates a process that excludes an arrangement which includes a print target image having a side not overlapping the sides of other print target images on the basis of lengths of cutoff lines in a rectangle circumscribing the print target images. This configuration is also achieved by the control section 20 performing an allocation process illustrated in FIG. 7 at S120 in FIG. 2. In the allocation process illustrated in FIG. 7, a step same as S205 is performed in S405. Note that, in FIG. 7, the total number of combinations is expressed as “M”, and the number “m” (m is any of one to M) is assigned to each of the combinations.

Subsequently, the control section 20 specifies a rectangle circumscribing print target images in a combination m (the initial value is set to m=1) to obtain a length “O” of the periphery of the rectangle (S410). For example, each of the rectangles indicated by bold lines in FIGS. 4D and 4E is the rectangle circumscribing print target images. The control section 20 obtains a perimeter length of such a rectangle. Then, the control section 20 determines whether the variable m indicating a combination is equal to M indicating the total number of the combinations or not (S415). In the case where the control section 20 does not determine that m is equal to M in S415, m is incremented (S420) to repeat the steps from S410.

In the case where the control section 20 determines that m is equal to M in S415, the control section 20 compares each of the perimeter lengths O with each other to obtain a combination in which the perimeter length O comes to be the shortest (S425). Note that the total number of the combinations obtained in S425 is set to be N.

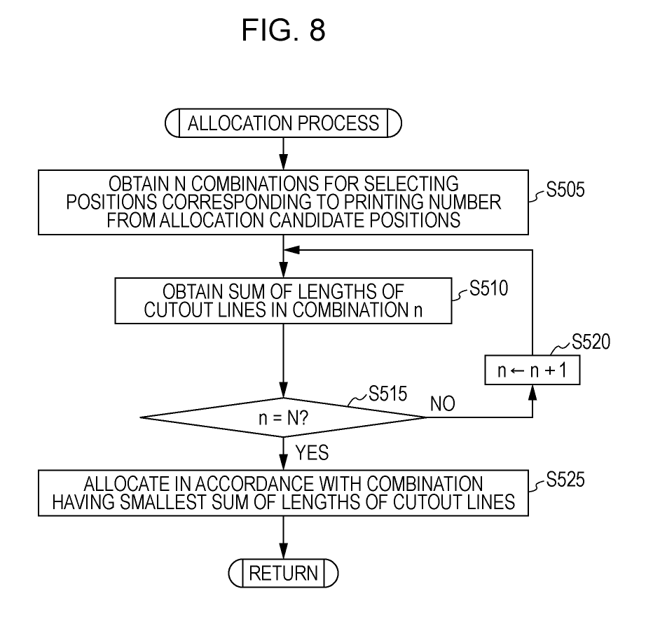

Subsequently, the control section 20 performs steps same as S310 to S325 in FIG. 5 to the obtained N combinations (S430 to S445). Namely, a combination in which the number of line segments as cutoff lines comes to be the least is extracted from the N combinations obtained in S425. Then, the control section 20 returns to the process illustrated in FIG. 2 to print an image which has been allocated in accordance with the extracted combination. Consequently, combinations which are determined to be obviously excluded through counting the number of line segments may be preliminarily excluded, and then the number of the line segments can be counted to specify the most appropriate combination. Of course, the configuration in which the counting is preliminarily limited in the manner described above may be applied to the process illustrated in FIG. 3 or may be applied to the process illustrated in FIG. 8.

Furthermore, a configuration may be adopted such that allocation which causes the cutting to be carried out with the shortest length of cutoff lines is considered to have the highest cutting efficiency. This configuration is also achieved by the control section 20 performing an allocation process illustrated in FIG. 8 at S120 in FIG. 2. In the allocation process illustrated in FIG. 8, S505 is the same step as S205.

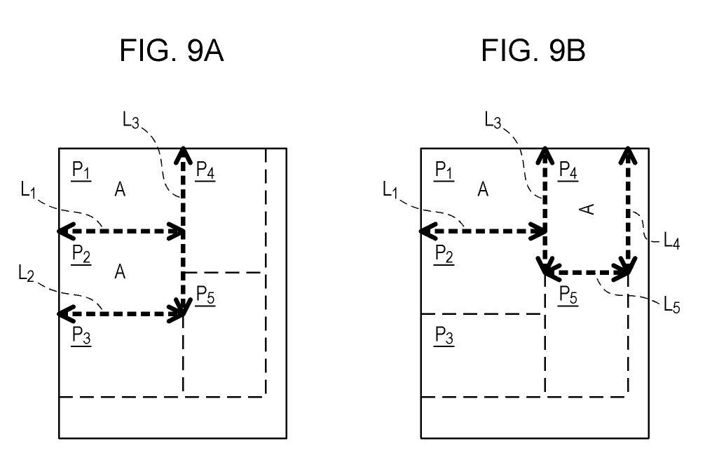

After N combinations have been obtained, the control section 20 obtains the sum of lengths of cutoff lines in a combination n while regarding the initial value of n as one (S510). In the embodiment, because a length of a line along which a printing medium is actually cut is considered, among defining lines that define each of the allocation candidate positions, the sum of lengths of the defining lines which correspond with the sides of the print target images is specified. For example, FIGS. 9A and 9B illustrate two examples of combination in which printing target images are arranged in the printing number two for the examples same as those illustrated in FIGS. 4A to 4C. In the examples, each of the cutoff lines to be actually cut is represented by a dashed arrow for indicating two ends of each cutoff line.

FIG. 9A illustrates the allocation of the print target images in the allocation candidate positions P₁ and P₂. FIG. 9B illustrates the allocation of the print target images in the allocation candidate positions P₁ and P₄. In FIG. 9A, cutoff lines constituted by the sides of the print target images arranged in the allocation candidate positions P₁ and P₂ are line segments L₁, L₂, and L₃, then the sum of the line segments is specified as the sum of the cutoff lines (in the example illustrated in FIG. 9A, 3+3+4=10). In addition, in FIG. 9B, cutoff lines constituted by the sides of the print target images arranged in the allocation candidate positions P₁ and P₄ are line segments L₁, L₃, L₄, and L₅, then the sum of the line segments is specified as the sum of the cutoff lines (in the example illustrated in FIG. 9B, 3+3+3+2=11).

Subsequently, the control section 20 determines whether the variable n indicating a combination is equal to N indicating the total number of the combinations or not (S515). In the case where the control section 20 does not determine that n is equal to N in S515, the n is incremented (S520) to repeat the steps from S510. On the other hand, in the case where the control section 20 determines that n is equal to N in S515, the control section 20 specifies a combination in which the sum of the lengths of the line segments obtained in S510 comes to be the smallest, and then the allocation is performed in accordance with the specified combination (S525). After the above steps have finished, the control section 20 returns to the process illustrated in FIG. 2 to perform the print control process. Consequently, among the combinations of arrangement which are able to be employed in the printing of the print target images in the specified printing number, printing can be performed in a combination of arrangement in which the print target images can be separated in the shortest cutting length compared to the other combinations. As a result, the cutting operation can be performed with high efficiency to separate a printing material into segments for the individual print target images.

What is claimed is:

1. An allocation device comprising:
an allocation candidate information acquisition unit that acquires a plurality of allocation candidate positions and the number of the allocation candidate positions in the case where print target images are allocated on a printing medium;
a printing number acquisition unit that acquires the number of the print target images to be printed, the number being smaller than the number of the allocation candidate positions; and
an allocation unit that allocates the print target images to the plurality of allocation candidate positions so that a highest cutting efficiency is obtained in the case where the printing medium, on which the print target images to be printed have been allocated and printed to the plurality of allocation candidate positions, is cut into segments for the individual print target images.

2. The allocation device according to claim 1, wherein the allocation unit allocates the print target images to the allocation candidate positions so that a largest non-printed portion is separated from the printing medium by cutting along one continuous cutoff line.

3. The allocation device according to claim 1, wherein the allocation unit allocates the print target images to the allocation candidate positions so that a smallest number of line segments are used as the cutoff lines, the cutoff lines being used for cutting the printing medium on which the print target images have been allocated to the allocation candidate positions into the segments for the individual print target images.

4. The allocation device according to claim 1, wherein the allocation unit allocates the print target images to the allocation candidate positions so that a total length of the cutoff lines is shortest, the cutoff lines being used for cutting the printing medium on which the print target images have been allocated to the allocation candidate positions into the segments for the individual print target images.

5. An allocation method comprising:
acquiring information on a plurality of allocation candidate positions and the number of the allocation candidate positions in the case where print target images are allocated on a printing medium;
acquiring the number of the print target images to be printed, the number being smaller than the number of the allocation candidate positions; and
allocating the print target images to the plurality of allocation candidate positions so that a highest cutting efficiency is obtained in the case where the printing medium, on which the print target images to be printed have been allocated and printed to the plurality of allocation candidate positions, is cut into segments for the individual print target images.

6. A recording medium, having an allocation program allowing a computer to execute the functions of:
acquiring information on a plurality of allocation candidate positions and the number of the allocation candidate positions in the case where print target images are allocated on a printing medium;
acquiring the number of the print target images to be printed, the number being smaller than the number of the allocation candidate positions; and
allocating the print target images to the plurality of allocation candidate positions so that a highest cutting efficiency is obtained in the case where the printing medium, on which the print target images to be printed have been allocated and printed to the plurality of allocation candidate positions, is cut into segments for the individual print target images.
